(19) United States
(12) Patent Application Publication
(10) Pub. No.: US 2012/0050398 A1
(43) Pub. Date: Mar. 1, 2012

(54) INKJET PRINTING APPARATUS

(75) Inventors: Ryota YAMAGISHI, Ibaraki-ken (JP); Tomohiko SHIMODA, Ibaraki-ken (JP)

(73) Assignee: RISO KAGAKU CORPORATION, Tokyo (JP)

(21) Appl. No.: 13/211,918

(22) Filed: Aug. 17, 2011

(30) Foreign Application Priority Data
Aug. 31, 2010 (JP) 193457/2010

(51) Int. Cl. B41J 2/165

(52) U.S. Cl. 347/30

(57) ABSTRACT

An inkjet printing apparatus includes: an inkjet head; a head holder for holding the inkjet head; a platen positioned below the head holder to face the head holder, the platen including a plurality of through holes formed therein; suction means for generating a suction force at the through holes; and a porous platen belt traveling over the platen for suctioning and conveying a paper sheet. The head holder separates between an upper space above the head holder and a lower space below the head holder, and includes a plurality of air holes, which allow communication of air between the upper space and the lower space, within a projection range of the platen onto the head holder. The total opening area of the air holes is 20 percent or more of the total projection area of the inkjet head onto the head holder.

### BACKGROUND OF THE INVENTION

1. Field of the Invention

The present invention relates to an inkjet printing apparatus. More particularly, the present invention relates to an inkjet printing apparatus provided with a head holder for holding inkjet heads, which eject ink.

2. Description of the Related Art

It is known with inkjet printing apparatuses that a printing stage (which will hereinafter be referred to as “platen”), which includes in the surface thereof a number of through holes for generating a suction force to correct for deformation, such as curl or cockling, of a paper sheet, is provided at a position facing an inkjet head, which ejects ink, and a porous platen belt is provided to slide over the platen to suction and convey the paper sheet.

When the belt holes which are not completely closed by the paper sheet, among the belt holes of the platen belt, pass above the through holes of the platen, the air above the platen belt flows into an area below the platen through the belt holes and the through holes, thereby generating streams of air above the platen belt.

The streams of air above the platen belt may scatter fine ink droplets (which will hereinafter be referred to as “ink mist”), which are formed when the ink is ejected, and may cause contamination of the paper sheet. Japanese Utility Model Registration No. 3135376 (hereinafter, Patent Document 1) has proposed a technique to reduce the contamination due to the ink mist by providing a suction air guide around the inkjet head to reduce the speed of the stream of air in the vicinity of the inkjet nozzles.

The contamination due to the ink mist is highly likely to be caused by a stream of air that flows between the paper sheet and the inkjet head.

Although the technique proposed in Patent Document 1 reduces the speed of the stream of air in the vicinity of the inkjet head, it has become difficult in recent years to provide the suction air guide, as disclosed in Patent Document 1, around the inkjet head, because of increasing demands for high-density inkjet heads, where a plurality of inkjet heads are held by a single head holder, along with demands for size reduction.

### SUMMARY OF THE INVENTION

In view of the above-described circumstances, the present invention is directed to providing an inkjet printing apparatus provided with a head holder which can reduce the contamination due to the ink mist.

In order to solve the above-described problem, an inkjet printing apparatus of the invention includes: an inkjet head; ahead holder for holding the inkjet head; a platen positioned below the head holder to face the head holder, the platen including a plurality of through holes formed therein; suction means for generating a suction force at the through holes; and a porous platen belt traveling over the platen for suctioning and conveying a paper sheet, wherein the head holder separates between an upper space above the head holder and a lower space below the head holder, and the head holder includes a plurality of air holes formed therein within a projection range of the platen onto the head holder, the air holes allowing communication of air between the upper space and the lower space, and wherein the air holes has a total opening area of 20 percent or more of a total projection area of the inkjet head onto the head holder.

The “air holes” herein refer to air holes formed in the head holder within the projection range of the platen. However, if the inkjet head includes the air holes inside the inkjet head, the air holes inside the head are also counted in determining “the total opening area of the air holes”. If the inkjet head includes the air holes inside the inkjet head, the projection area of the head excluding the air holes inside the head is the “total projection area of the inkjet head” onto the head holder.

In the inkjet printing apparatus of the invention, the air holes may be provided in the vicinity of opposite sides of the inkjet head to extend along the inkjet head.

The “vicinity of opposite sides of the inkjet head” herein refers to that the edges of the air holes nearer to the inkjet head are positioned in the vicinity of the opposite sides of the inkjet head, and specifically that the edges nearer to the inkjet head are positioned within 15 mm, desirably 10 mm, or more desirably 5 mm from the inkjet head.

In the inkjet printing apparatus of the invention, the head holder may hold the inkjet head with the inkjet head being inserted in an attachment hole formed in the head holder, and the air holes may be formed by a clearance between the attachment hole and the inkjet head.

In the inkjet printing apparatus of the invention, the air holes may be formed in an area which includes at least a part of projection areas of the through holes onto the head holder.

In the inkjet printing apparatus of the invention, the air holes may have a total opening area of 50 percent or more of a total projection area of the inkjet head onto the head holder.

The inkjet printing apparatus of the invention may further include air pressure adjusting means for providing the upper space with an air pressure higher than an atmospheric pressure.

According to the invention, the inkjet printing apparatus includes: an inkjet head; a head holder for holding the inkjet head; a platen positioned below the head holder to face the head holder, the platen including a plurality of through holes formed therein; suction means for generating a suction force at the through holes; and a porous platen belt traveling over the platen for suctioning and conveying a paper sheet, wherein the head holder separates between an upper space above the head holder and a lower space below the head holder, and the head holder includes a plurality of air holes formed therein within a projection range of the platen onto the head holder, the air holes allowing communication of air between the upper space and the lower space, and wherein the air holes has a total opening area of 20 percent or more of a total projection area of the inkjet head onto the head holder. With this structure, the air between the head holder and the belt holes which are not completely closed by the paper sheet flows more easily into the belt holes which are not completely closed by the paper sheet than the air between the paper sheet and the inkjet head in the upper space above the head holder, thereby reducing the contamination due to the ink mist.

### BRIEF DESCRIPTION OF THE DRAWINGS

FIG. 1 is a schematic structural diagram of an inkjet printing apparatus,

FIG. 2 contains a plan view and a perspective view of a head holder,

FIG. 3 is a plan view of a platen,

FIG. 4 is a partially enlarged sectional view of a printing section,

FIG. 5 is a diagram illustrating a first embodiment of air holes,

FIG. 6 is a diagram illustrating a second embodiment of the air holes,

FIG. 7 is another diagram illustrating the second embodiment of the air holes,

FIG. 8 is a diagram illustrating a third embodiment of the air holes, and

FIG. 9 is a diagram illustrating a fourth embodiment of the air holes.

### DESCRIPTION OF THE PREFERRED EMBODIMENTS

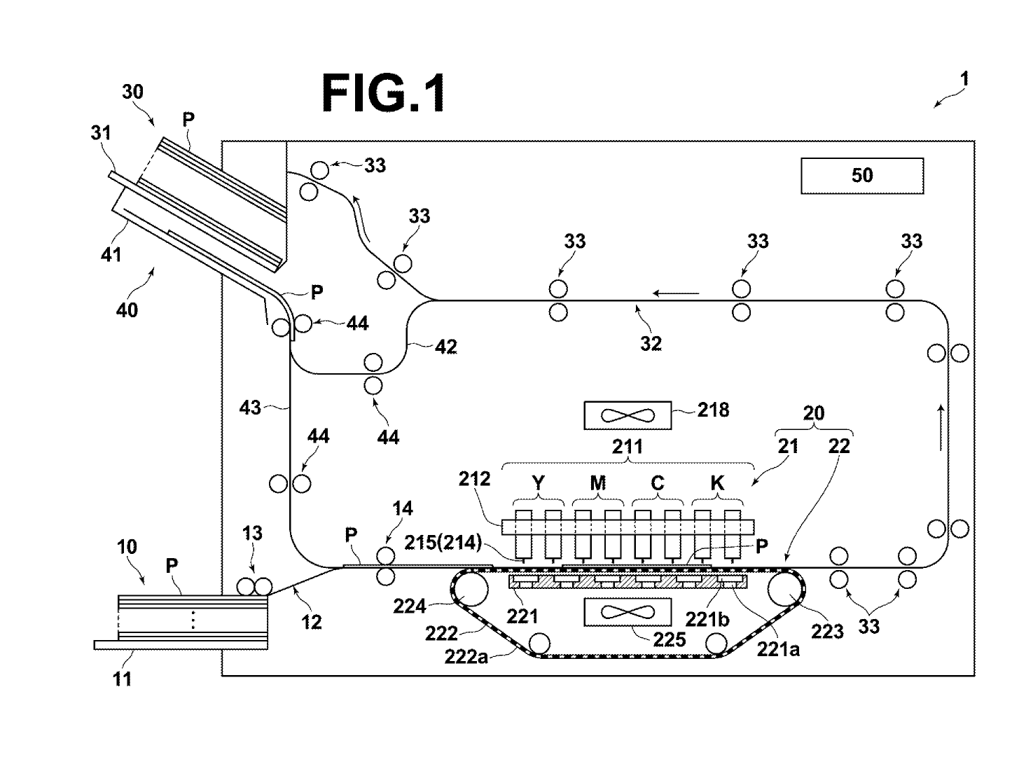

Hereinafter, embodiments of the present invention will be described with reference to the drawings. FIG. 1 is a schematic structural diagram of an inkjet printing apparatus 1 according to embodiments of the invention. The inkjet printing apparatus 1 includes a paper feed section 10, a printing section 20, a paper discharge section 30, a reversing section 40 and a control section 50.

The paper feed section 10 feeds paper sheets P to the printing section 20. The paper feed section 10 includes: a paper feed tray 11, on which unprinted paper sheets P are stacked, disposed at a lower side surface of the inkjet printing apparatus 1; a paper feed path 12 to guide each paper sheet P from the paper feed tray 11 to the printing section 20; a pair of paper feed rollers 13 to take out the paper sheets P one by one from the paper feed tray 11; and a pair of timing rollers 14 to send each paper sheet P into the printing section 20 at predetermined timing.

The printing section 20 conveys the paper sheet P from the paper feed section 10, ejects ink onto the paper sheet P to achieve printing, and conveys the paper sheet P to the paper discharge section 30. The printing section 20 includes a head unit 21 to eject ink, and a platen unit 22 to convey the paper sheet P below the head unit 21. Details about the head unit 21 and the platen unit 22 will be described later.

The paper discharge section 30 conveys and discharges the printed paper sheet P. The paper discharge section 30 includes: a paper discharge tray 31, on which printed paper sheets P are stacked, disposed at the upper side surface of the inkjet printing apparatus 1; a paper discharge path 32 to guide each printed paper sheet P with the printed surface thereof facing down from the printing section 20 to the paper discharge tray 31; and a pair of paper discharge rollers 33 to send out the paper sheets P on the paper discharge path 32 one by one.

The reversing section 40 reverses the conveyance direction of single-side printed paper sheets P and sends each paper sheet P with the unprinted surface thereof facing up again to the printing section 20. The reversing section 40 includes: a buffer space 41 provided on the back side of the paper discharge tray 31; a branching path 42 branching at the middle of the paper discharge path 32 to guide each paper sheet P to the buffer space 41; a paper refeeding path 43 to guide each paper sheet P from the buffer space 41 to the pair of timing rollers 14; and pairs of reversing rollers 44 to send out the paper sheets P on the branching path 42 and the paper refeeding path 43 one by one.

The control section 50 controls operations of each section and processes instructions from the user inputted via an operation panel (not shown).

Next, the entire operation of the inkjet printing apparatus 1 is described. An unprinted paper sheet P is taken out from the paper feed tray 11 onto the paper feed path 12 by the pair of paper feed rollers 13. The paper sheet P on the paper feed path 12 is sent to the printing section 20 by the pair of timing rollers 14 at predetermined timing.

In the printing section 20, the platen unit 22 conveys the paper sheet P at a predetermined speed, and the head unit 21 ejects ink onto the paper sheet P to achieve printing. The printed paper sheet is sent onto the paper discharge path 32 one by one by the pair of paper discharge rollers 33, and is guided with the printed surface thereof facing down to the paper discharge tray 31 to be discharged.

In the case where double-side printing is carried out, a path switching mechanism (not shown) disposed at the middle of the paper discharge path 32 sends the paper sheet P on the paper discharge path 32 to the branching path 42 and guides the paper sheet P to the buffer space 41. Then, the paper sheet P is sent from the buffer space 41 to the paper refeeding path 43, and is again guided to the pair of timing rollers 14 to be refeeded to the printing section 20. In the following description, a direction perpendicular to the conveyance direction of the paper sheet P is referred to as a main-scanning direction, and the conveyance direction of the paper sheet P is referred to as a sub-scanning direction.

Now, the head unit 21 of the printing section 20 is described. The head unit 21 includes a plurality of inkjet heads 211, which eject ink toward the paper sheet P, and a head holder 212 to hold the inkjet heads 211.

The head holder 212 is positioned above the platen 221, which will be described later, to face the platen 221. The head holder 212 separates between an upper space US above the head holder 212 and a lower space LS below the head holder 212. The head holder 212 includes air holes 216 formed within a projection range PR of the platen 221. The air holes 216 allow communication of air between the upper space US and the lower space LS.

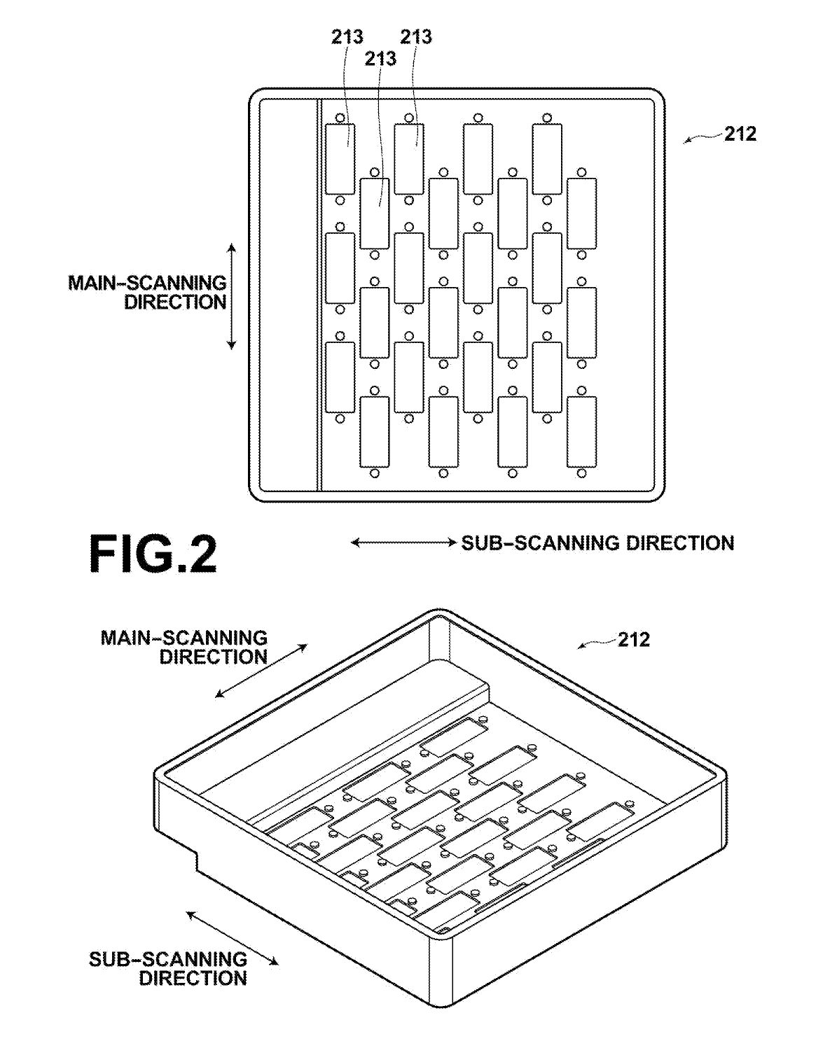

FIG. 2 is a diagram illustrating the head holder 212, where the upper figure is a plan view of the head holder 212 and the lower figure is a perspective view of the head holder 212. As shown in FIG. 2, the head holder 212 includes a plurality of attachment holes 213, which are formed in a staggered pattern at predetermined intervals along the main-scanning direction and the sub-scanning direction. In this embodiment, the head holder 212 includes a total of 24 attachment holes 213. Details about the above-mentioned air holes 216 will be described later. It should be noted that the number and positioning of the attachment holes 213 are not particularly limited.

The head holder 212 holds the inkjet heads 211, where each inkjet head 211 is inserted into each attachment hole 213 using a flange (not shown), or the like. Referring again to FIG. 1, each inkjet head 211 includes, at the lower surface thereof, inkjet nozzles 214, which eject ink toward the paper sheet P. The inkjet nozzles 214 are arranged along the sub-scanning direction at the lower surface of the inkjet head 211 to form a linear nozzle array 215. That is, each inkjet head 211 ejects ink toward the paper sheet P line by line.

In this embodiment, six inkjet heads 211 which eject ink of the same color are grouped to eject one of colors including black K, magenta M, cyan C and yellow Y.

Now, referring again to FIG. 1, the platen unit 22 is described. The platen unit 22 includes: a platen 221, which is positioned below the head unit 21 to face the head holder 212; an endless platen belt 222 disposed to slide over the platen 221; a driving roller 223 to drive the platen belt 222; a driven roller 224; and a fan 225 to provide a negative pressure in the space below the platen 221.

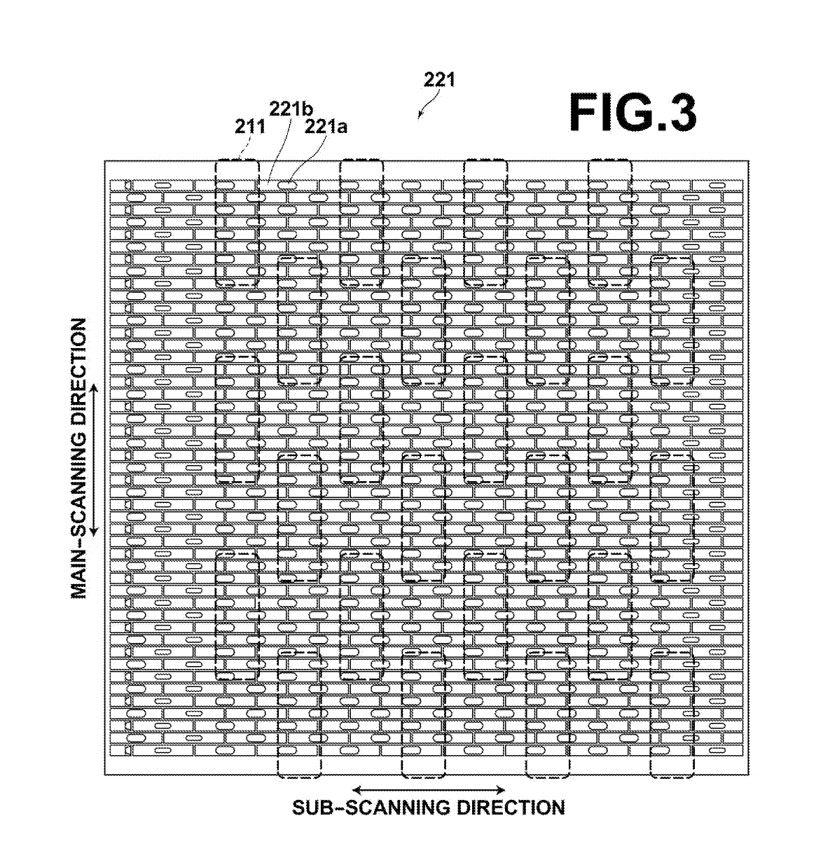

FIG. 3 is a plan view of the platen 221. In FIG. 3, a projection position of each inkjet head 211 is indicated by the dashed line. The platen 221 is a plate member, and includes a plurality of elongate through holes 221a formed in a staggered pattern in a range where the platen belt 222 passes. Further, depressions 221b, which communicate with the through holes 221a, are formed in the surface of the platen 221.

The platen belt 222 includes a plurality of belt holes 222a formed in a staggered pattern. When the fan 225 provides a negative pressure in the space below the platen 221, a suction force is generated at each through hole 221a. It should be noted that the space below the platen 221 is sealed with a frame (not shown).

When the platen belt 222 slides over the platen 221, a suction force is also generated at the belt holes 222a passing over the depressions 221b. The suction force generated at the belt holes 222a is maximized when the belt holes 222a pass above the through holes 221a. A distance between the surface of the platen belt 222 and each inkjet nozzle 214 is adjusted depending on the thickness of the paper sheet P, and is within a range from about 1 to 3 mm.

The leading edge, which is upstream in the sub-scanning direction, of the paper sheet P sent out by the pair of timing rollers 14 is detected by a sensor (not shown), and the paper sheet P is suctioned and held on the platen belt 222 by the belt holes 222a to be conveyed. When the paper sheet P passes through a position UP just under the inkjet nozzles 214 at a predetermined speed, each inkjet head 211 ejects ink line by line to form an image on the paper sheet P. It should be noted that timing of the ejection of ink by the head unit 21 and timing of the conveyance of the paper sheet P by the platen unit 22 are controlled by the control section 50.

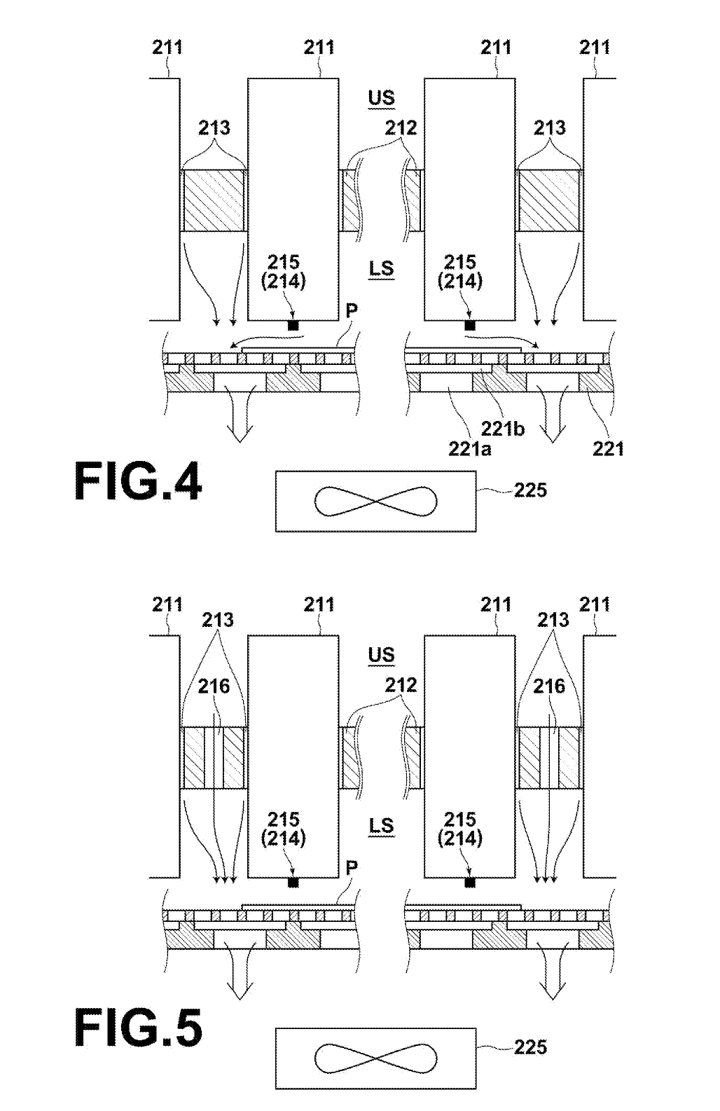

FIG. 4 is a partially enlarged sectional view of the printing section 20. FIG. 4 shows a state where printing is started. As described above, the suction force is generated at the belt holes 222a when the belt holes 222a pass above the depressions 221b, and the suction force is maximized when the belt holes 222a pass above the through holes 221a. When the belt holes 222a which are not completely closed by the paper sheet P, among the belt holes 222a, pass above the depressions 221b, the air above the platen belt 222 flows into the space below the platen belt 222 through the belt holes 222a, the depressions 221b and the through holes 221a, and the streams of air indicated by the arrows in the drawing are generated above the platen belt 222. The streams of air are maximized when the belt holes 222a pass above the through holes 221a.

Among these streams of air, when the stream of air that flows between the paper sheet P and the inkjet head 211 increases, a possibility of scattering of the ink mist from the inkjet nozzles 214, and thus contamination of the printed image, is increased.

Now, the air holes 216 provided in the head holder 212 are described. As described above, the head holder 212 includes the air holes 216, as shown in FIG. 5, which allow communication of air between the upper space US above the head holder 212 and the lower space LS below the head holder 212 within the projection range PR of the platen 221. Description is made with respect to FIG. 5 with assuming that the air holes 216 are provided between the inkjet heads 211.

The positions of the air holes 216 in the head holder 212 are not particularly limited as long as the air holes 216 are provided within the projection range PR of the platen 221. The air holes 216 are formed in the head holder 212 such that the total opening area of the air holes 216 is 20 percent or more, desirably 50 percent or more, or more desirably 80 percent or more of the total projection area of the inkjet heads 211 onto the head holder 212, and not more than 90 percent in view of the strength of the head holder 212.

With this, the air above the belt holes 222a which are not completely closed by the paper sheet P flows more easily into the belt holes 222a which are not completely closed by the paper sheet P than the air between the paper sheet P and the inkjet heads 211. Therefore, the stream of air flowing between the paper sheet P and the inkjet heads 211 decreases, thereby reducing the contamination due to the ink mist.

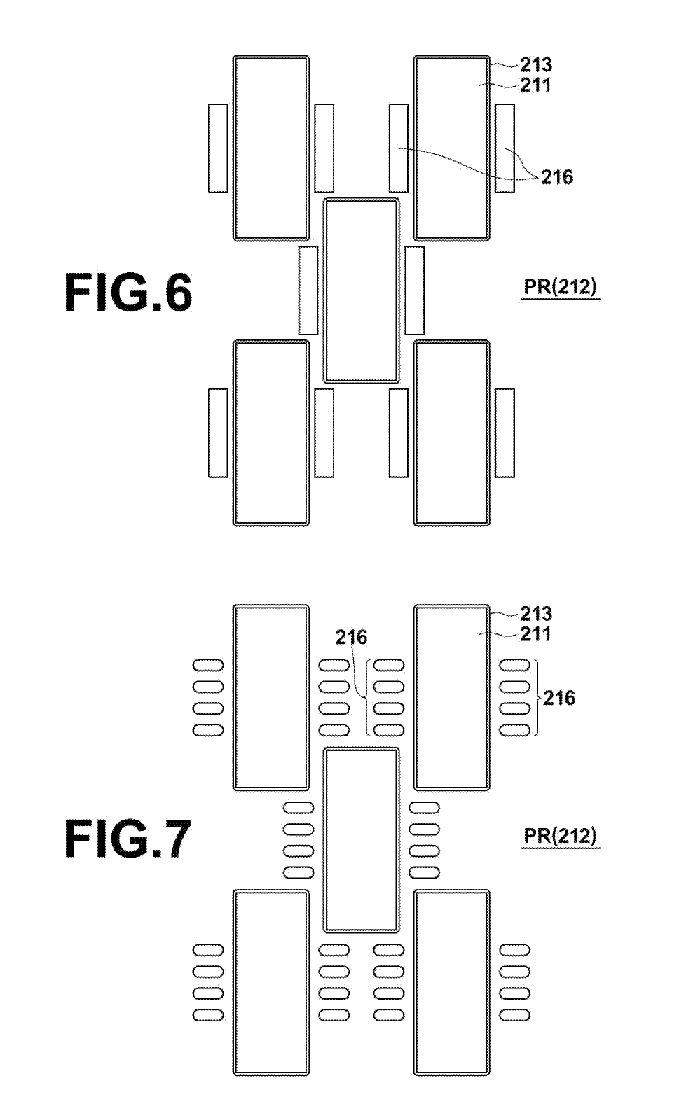

Next, a second embodiment of the air holes 216 is described. In the second embodiment, the air holes 216 are formed in the vicinity of the opposite sides of the inkjet heads 211. FIG. 6 is a diagram illustrating the second embodiment of the air holes 216. As shown in FIG. 6, the edges of the air holes 216 nearer to the inkjet heads 211 extend along the vicinity of the opposite sides of the inkjet heads 211. Specifically, the vicinity of the inkjet heads 211 refers to that the edges nearer to the inkjet heads 211 are positioned within 15 mm, desirably 10 mm, or more desirably 5 mm from the inkjet heads 211.

In the second embodiment, the total area of the air holes 216 extending along the inkjet heads 211 in the vicinity of the opposite sides of the inkjet heads 211 is 20 percent or more, desirably 50 percent or more, or more desirably 80 percent or more of the total projection area of the inkjet heads 211, and desirably not more than 90 percent in view of the strength of the head holder 212.

FIG. 6 shows an example where, for each inkjet head 211, one rectangular air hole 216 is formed in the vicinity of each of the opposite sides of the inkjet head 211 (i.e., two air holes 216 are formed for each inkjet head 211) to provide the projection area ratio of the air holes 216 of about 27 percent for each inkjet head 211.

FIG. 7 shows a variation of the second embodiment. Although the air holes 216 shown in FIG. 6 are rectangular holes provided on opposite sides of the inkjet heads 211, the shape of the holes is not limited, and may be square, rectangular, elliptic, circular or triangular. In particular, if the holes are triangular, it is desirable to orient the holes such that the base of the triangle is positioned nearer to the inkjet head 211. The shape of the air holes 216 shown in FIG. 7 is elongate, which is the same shape as that of the through holes 221a.

Further, the air holes 216 are not limited to those provided one by one on each side of each inkjet head 211, as shown in FIG. 6, and two or more holes may be formed on each side of each inkjet head 211. In FIG. 7, four air holes 216 are formed on each side of each inkjet head 211.

The “opposite sides of the inkjet heads 211” are not limited to the opposite sides of the inkjet heads 211 in the sub-scanning direction, as shown in FIG. 6, and may be opposite sides in the main-scanning direction or opposite sides in the main-scanning direction and the sub-scanning direction. In other words, the air holes 216 may be formed between the inkjet heads 211, which are disposed in the staggered pattern.

Also, the size of the air holes 216 is not particularly limited, as long as the total area of the air holes 216 is 20 percent or more of the total projection area of the inkjet heads 211. Therefore, the air holes 216 in FIG. 7 may be smaller than the through holes 221a.

Providing the air holes 216 in the vicinity of the opposite sides of the inkjet heads 211 in this manner, the air in the vicinity of the inkjet heads 211 in the space above the belt holes 222a which are not completely closed by the paper sheet P flows more easily along the inkjet heads 211, and thus the stream of air flowing between the paper sheet P and the inkjet heads 211 is reduced, thereby reducing the contamination due to the ink mist.

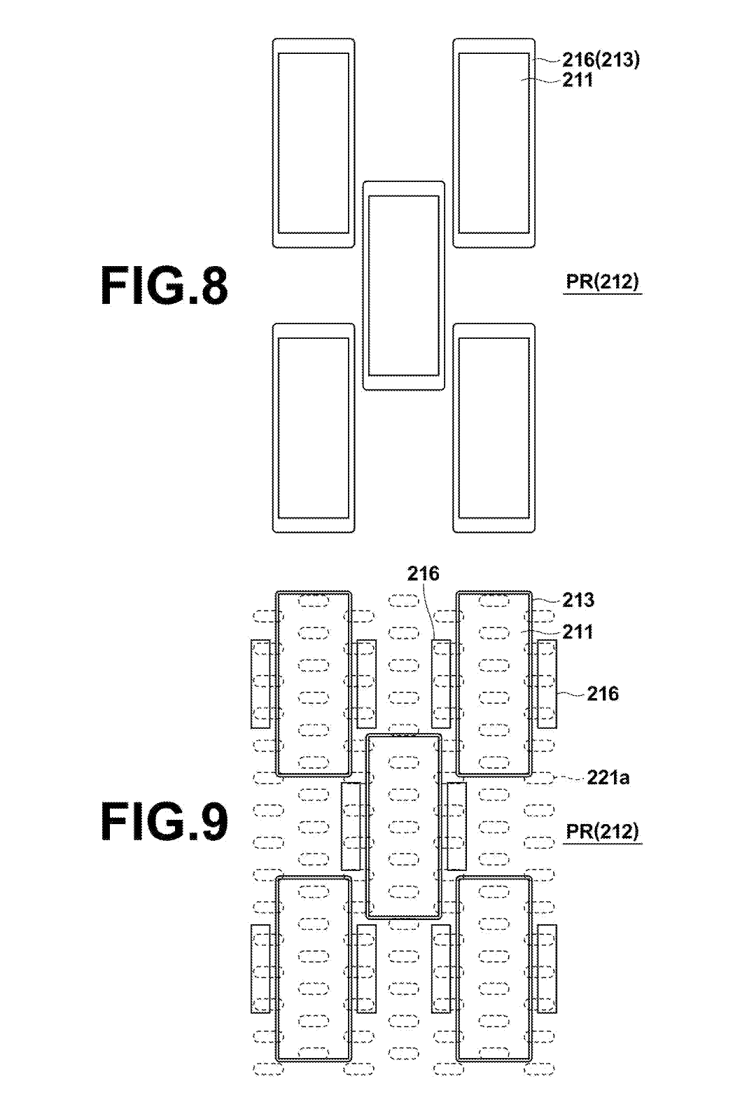

Next, a third embodiment of the air holes 216 is described. In the third embodiment, the attachment holes 213 are used as the air holes 216. FIG. 8 is a diagram illustrating the third embodiment of the air holes 216. In the third embodiment, the air holes 216 having a shape which is offset outward from each attachment hole 213 are formed around the attachment holes 213.

In the third embodiment, the air holes 216 are formed in the head holder 212 such that the total area of clearances between the attachment holes 213 and the inkjet heads 211 is 20 percent or more, desirably 50 percent or more, or more desirably 80 percent or more of the total projection area of the inkjet heads 211, and not more than 90 percent in view of the strength of the head holder 212.

FIG. 8 shows an example where, for each inkjet head 211 having the same projection area as that in the first embodiment, the air hole 216 having a shape that is offset outward from the attachment hole 213 is formed around the attachment hole 213 to provide the projection area ratio of the air hole 216 of about 32 percent for each inkjet head 211.

By utilizing the attachment holes 213 in this manner, the air nearer to the inkjet heads 211 in the space above the belt holes 222a which are not completely closed by the paper sheet P more easily flows along the inkjet heads 211, and thus the stream of air flowing between the paper sheet P and the inkjet head 211 is reduced, thereby reducing the contamination due to the ink mist.

Further, the air holes 216 are formed to include at least a part of projection areas of the through holes 221a. FIG. 9 is a diagram illustrating a fourth embodiment of the air holes 216. The fourth embodiment here is applied to the second embodiment; however, the fourth embodiment is also applicable to the first and third embodiments.

As described above, the stream of air above the platen belt 222 is maximized when the belt holes 222a which are not completely closed pass above the through holes 221a. Therefore, as shown in FIG. 9, by forming the air holes 216 to include at least a part of the projection areas of the through holes 221a indicated by the dashed lines in the drawing, the air immediately above the belt holes 222a which are not completely closed by the paper sheet P in the space above the belt holes 222a which are not completely closed by the paper sheet P more easily flows into the belt holes 222a, and thus the stream of air flowing between the paper sheet P and the inkjet head 211 is reduced, thereby reducing the contamination due to the ink mist.

Further, in the first to fourth embodiments, the upper space US above the head holder 212 may be sealed with a frame (not shown), or the like, and an air pressure adjusting means 218, as shown in FIG. 1, may be provided in the upper space US to provide an air pressure in the upper space US higher than the atmospheric pressure. This allows the air between the head holder 212 and the belt holes 222a which are not completely closed by the paper sheet P to flow into the belt holes 222a more easily than the air between the paper sheet P and the inkjet head 211. It should be noted that the first to fourth embodiments may be applied in combination.

As described above, according to the inkjet printing apparatus 1, the air holes 216, which allow communication of air between the upper space US and the lower space LS are formed within the projection range PR of the head holder 212 separating between the upper space US and the lower space LS, such that the total opening area of the air holes 216 is 20 percent or more of the total projection area of the inkjet heads 212 onto the head holder 212. This allows the air above the belt holes 222a which are not completely closed in the lower space LS to flow into the belt holes 222a more easily than the air between the paper sheet P and the inkjet head 211. Therefore, the stream of air flowing between the paper sheet P and the inkjet head 211 is reduced, thereby reducing the contamination due to the ink mist.

Further, according to the inkjet printing apparatus 1, the air holes may be formed in the vicinity of the opposite sides of the inkjet heads to extend along the inkjet heads. This allows the air above the belt holes 222a which are not completely closed and in the vicinity of the inkjet heads 211 to flow more easily along the inkjet heads 211, thereby reducing the contamination due to the ink mist.

Still further, according to the inkjet printing apparatus 1, the clearances between the inkjet heads 211 and the attachment holes 213, in which the inkjet heads 211 are inserted, may be used as the air holes 216. This allows the air above the belt holes 222a which are not completely closed and in the closer vicinity of the inkjet heads 211 to flow more easily along the inkjet heads 211, thereby reducing the contamination due to the ink mist. Further, this allows even higher density of the inkjet heads 211.

Yet further, according to the inkjet printing apparatus 1, the air holes 216 may be formed in areas including at least a part of the projection areas of the through holes 221a. This allows the air immediately above the belt holes 222a which are not closed flows more easily into the belt holes 222a, thereby reducing the contamination due to the ink mist.

Further, according to the inkjet printing apparatus 1, the air pressure adjusting means 218 may be provided to provide the air pressure in the upper space US higher than the atmospheric pressure. This allows the air in the upper space US to flow into the lower space LS, and thus the air above the belt holes 222a which are not completely closed flows more easily into the belt holes 222a, thereby reducing the contamination due to the ink mist.

What is claimed is:

1. An inkjet printing apparatus comprising:
an inkjet head;
a head holder for holding the inkjet head;
a platen positioned below the head holder to face the head holder, the platen including a plurality of through holes formed therein;
suction means for generating a suction force at the through holes; and
a porous platen belt traveling over the platen for suctioning and conveying a paper sheet,
wherein the head holder separates between an upper space above the head holder and a lower space below the head holder, and the head holder includes a plurality of air holes formed therein within a projection range of the platen onto the head holder, the air holes allowing communication of air between the upper space and the lower space, and
wherein the air holes has a total opening area of 20 percent or more of a total projection area of the inkjet head onto the head holder.

2. The inkjet printing apparatus as claimed in claim 1, wherein the air holes are provided in the vicinity of opposite sides of the inkjet head to extend along the inkjet head.

3. The inkjet printing apparatus as claimed in claim 2, wherein the head holder holds the inkjet head with the inkjet head being inserted in an attachment hole formed in the head holder, and
the air holes comprise a clearance between the attachment hole and the inkjet head.

4. The inkjet printing apparatus as claimed in claim 1, wherein the air holes are formed in an area including at least a part of projection areas of the through holes onto the head holder.

5. The inkjet printing apparatus as claimed in claim 1, wherein the air holes have a total opening area of 50 percent or more of a total projection area of the inkjet head onto the head holder.

6. The inkjet printing apparatus as claimed in claim 1, further comprising air pressure adjusting means for providing the upper space with an air pressure higher than an atmospheric pressure.
